(19) United States
(12) Patent Application Publication
(10) Pub. No.: US 2005/0225634 A1
(43) Pub. Date: Oct. 13, 2005

(54) Closed circuit TV security system

(76) Inventors: Sam Brunetti, Catharpin, VA (US); Lee Thew, Jefferson, MD (US); Douglas Vetter, Manassas, VA (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 10/818,002

(22) Filed: Apr. 5, 2004

(51) Int. Cl. H04N 7/18

(52) U.S. Cl. 348/143

(57) ABSTRACT

A closed circuit television system (10) includes a plurality of cameras (C1-Cn) installed throughout an area along routes (R1-Rn) followed by someone passing through the area. A touch screen monitor (18) displays camera images (SC). A console 12 operator selects which camera's image to display. The camera selected is a camera observing a person or object in a path by which the person or object is moving through the area. A tracking system (30) is responsive to the operator for selecting one or more additional cameras positioned along the routes the person or object would follow in moving from their current location. The monitor also displays images from each of these other selected cameras. The tracking system allows the operator to change the selection of cameras whose images are displayed in response to the route, and changes in route, as well as to initiate recording of the camera imagery.

### CROSS REFERENCE TO RELATED APPLICATIONS

### STATEMENT REGARDING FEDERALLY SPONSORED RESEARCH OR DEVELOPMENT

### BACKGROUND OF THE INVENTION

This invention relates closed circuit television (CCTV) systems used in security systems and the like to monitor activities at various locations on a premises, and more particularly, to a cctv system with directional decision capability for tracking a person's progress through an area so the person can be closely monitored.

Closed circuit television is extensively used in security systems which protect many types of premises. The systems employ cameras located at strategic locations throughout and/or about a facility. On the outside of the facility, cameras typically monitor doors or gates providing access to the facility. On the inside of the facility, cameras are positioned to monitor doors into and out of secure areas, vaults or other locations where values are kept, etc. It will appreciated that in addition to monitoring people, a closed circuit television system can also be used to track the movement of articles. In a manufacturing operation, cameras can monitor areas of a shop floor where bottlenecks occur. In warehouses, the cameras monitor storage areas to detect theft or pilferage.

Security system operation is such that images captured by the television cameras are fed to a monitoring location. At the monitoring site, the images are either simultaneously displayed on a series of monitors, or they are displayed in a sequential manner (A,B,C,A,B,C, etc.) on a single monitor. If a number of monitors are employed, sufficient security personnel must be available to observe whatever is occurring. If only one, or a few monitors or in use, the personnel are usually be able to stop the sequencing of cameras and monitor the output from only one camera when something of interest is observed.

The current systems have a number of drawbacks. A significant one of these is an inability to always conveniently track someone's or something's movement through a facility. Most buildings have more than one entrance and exit. There are also usually many paths a person or object can take in moving through an area. Currently, if a suspicious person is observed moving through an area, security personnel cannot always readily follow his movements. If a camera has pan, tilt, and zoom capability, the monitor can use these controls to follow the person's movement to some extent. However, once the person moves out of view of the camera, it becomes necessary to be able to quickly switch from that camera to another camera. The security personnel can attempt to track the movement by guessing which is the next camera with which to observe the person. If, however, the person has more than one option as to which way to go from area to another, selection of the wrong camera may allow him to move undetected into the next area. Even though the person may eventually be observed again with another camera, he or she may not be under observation for a considerable period of time. A lot can happen in the intervening period. Further, even if the security personnel correctly select which camera will next catch the person, they must still try to predict, each time the person moves out of camera range, where the person is going to go next.

It will also be appreciated that the circumstances under which the person is being observed can greatly complicate their tracking. Outdoors, at night or in inclement weather, low levels of illumination may allow the person to move undetected about the grounds. Indoors, at night or on weekends, during non-working periods, much of the lighting is shut-off or reduced in intensity, also making it difficult to track someone's movements. Finally, if the person is aware he is being observed, he can take evasive action (crouching as he moves, or trying to move only behind objects which block him from view) to avoid being observed.

There is a need, therefore, for a cctv system which enables security personnel to quickly and accurately track people or objects moving through a facility, which predicts paths of movement, and which automatically selects from among an array of cameras which will observe movement regardless of the chosen path.

### BRIEF SUMMARY OF THE INVENTION

Briefly stated, a closed circuit television (cctv) system of the present invention is for tracking the movement of a person within a facility such as an office building, factory, warehouse or the like. The system includes a plurality of cameras installed at selected locations within the facility. Individual cameras are installed along routes over which a person traveling through the facility will follow. A control station for the facility includes a touch screen monitor on which images from the cameras are displayed. The monitor displays both full size and reduced size images. A selection portion of the screen allows a user to select which camera's image to display. The selected camera is a camera in a path the person or an object is taking through the facility, and the image is displayed as a full size image. A tracking system is responsive to a camera selection to further select one or more additional cameras positioned along pathways the person or object would follow in moving through the facility from his or its current location. Images from each of these other selected cameras are displayed on the monitor as reduced size images. The tracking system also automatically changes the selection of cameras whose images are displayed on the monitor in response to the pathway, and changes in pathway, taken by the person or object.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 illustrates a security control console for a facility;

FIG. 2 is a perspective view of a touch screen monitor used the closed circuit television system of the present invention;

FIG. 3 is a representation of floor/area selection touch screen display;

FIG. 4 is a screen display for a selected floor/area illustration both the layout of the floor space of the area and the location of cameras in the area;

FIG. 5 is a screen display showing both a portion of the floor area and an image from a selected camera within the area; and,

FIG. 6 is a screen display in the selected camera is displayed as a full size image and images from the other selected images as reduced size images.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

In accordance with the present invention, a closed circuit television or cctv system is indicated generally 10 in the drawings. System 10 tracks the movement of a person or object through a facility F. The facility can be an office building, factory, processing center, warehouse, or other type of premises where it is important to know if a person (usually an unauthorized person) has accessed the facility; and, if so, what they are doing. It will be appreciated by those skilled in the art, that the system can also track various types of articles, whether these are items being manufactured, processed, or stored. The system of the present invention is particularly advantageous in automatically tracking movement of a person or item as it moves through the facility, without someone monitoring the premises having to try to sequence a series of cameras to effect the tracking. It will further be appreciated by those skilled in the art, that the system operates throughout the entire premises, including multi-floor facilities, and facilities having a number of widely separated areas of interest. As described herein, various imaging means (which can operate not only in the visible portion of the spectrum, but in the infrared region as well) are interposed in the pathways a person or article can take in moving through the premises. As the person, for example, is observed by a camera, a tracking system of the invention automatically determines which camera will next observe the person, this being done as a function of the paths he or she can take from their current location. This automatic sequencing function relieves security or other monitoring personnel of having to try to predict a pattern of movement. Heretofore, attempts to track the person meant that a number of cameras had to be simultaneously monitored if the person could readily choose more than one way to travel from a location. In a manufacturing or material processing environment, if the movement of an item is dependent upon certain parameters (pass/fail, for example), as each decision in the process is made, it automatically queues up a camera to follow the item or article based upon the result of the decision making process.

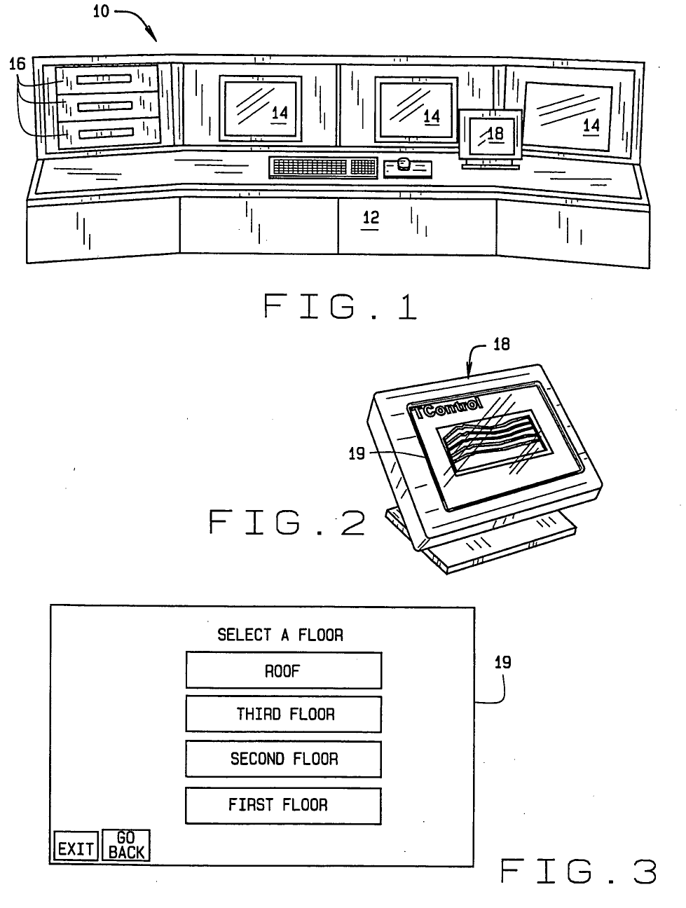

Referring to FIG. 1, a cctv system of the present invention is indicated generally 10 and includes a control console 12 at which a premises can be monitored. Console 12 includes one or more television monitors 14 by which video images obtained from cameras C located about the premises are displayed. One or more video recorders 16 located at the console are used to record and playback video images. In addition, a touch screen monitor 18 of the present invention is located at the console for use by the security personnel. While the monitors 14 operate in their conventional manner to display video images, monitor 18 is used with a tracking system 20 of the present invention when it is important to track the movement of a person or object through the facility.

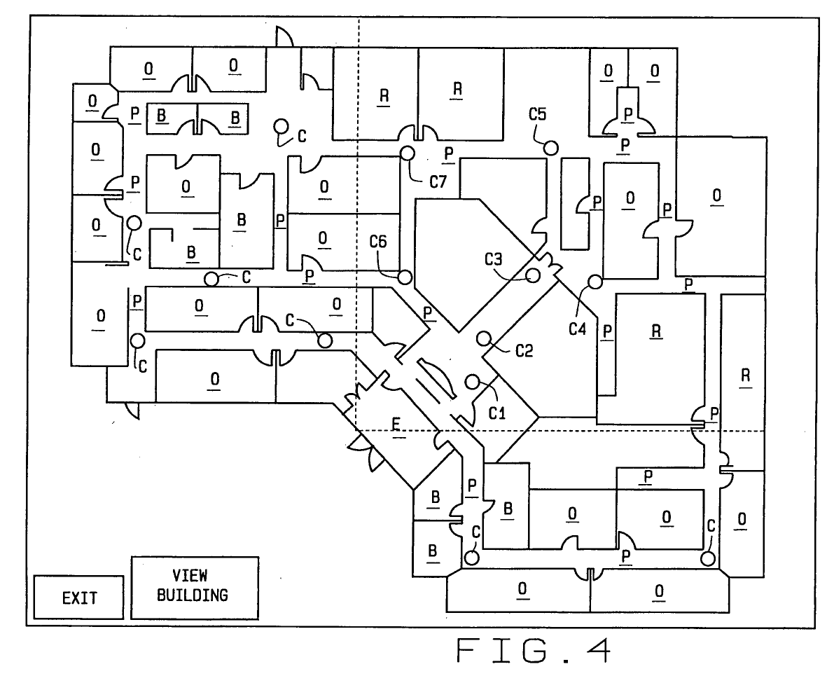

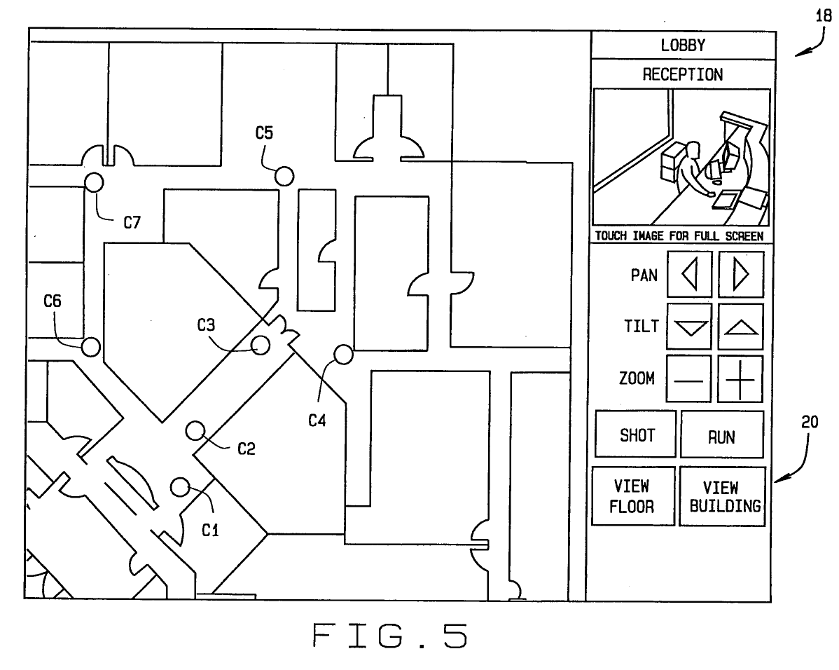

Referring to FIG. 4, a representation of an area being monitored by system 10 is shown to include offices 0, cubicles B, and conference rooms R. For sake of drawing convenience, not all of these areas are identified. Further, it will be understood that this representation is exemplary only. Movement through this complex is via pathways indicated generally P. These pathways includes aisles between offices, cubicles, etc., open areas, and areas adjacent doors leading into and out of the facility. System 10 includes cameras C located throughout the facility. It will be noted from a view of FIG. 4 that individual cameras are located along various of the pathways by which a person can move through the facility, at entrances and exits from the premises, and at intersections of various pathways. The representation of the floor plan for the area, including the location of the cameras C is provided as a display on monitor 18. Because a facility may include more than one floor or area monitored by system 10, a separate display is available for each area. As shown in FIG. 3, touch screen monitor includes a display in which each area is listed. By touching the portion of the screen for a particular area, the floor plan with camera locations is brought up as a display on the screen.

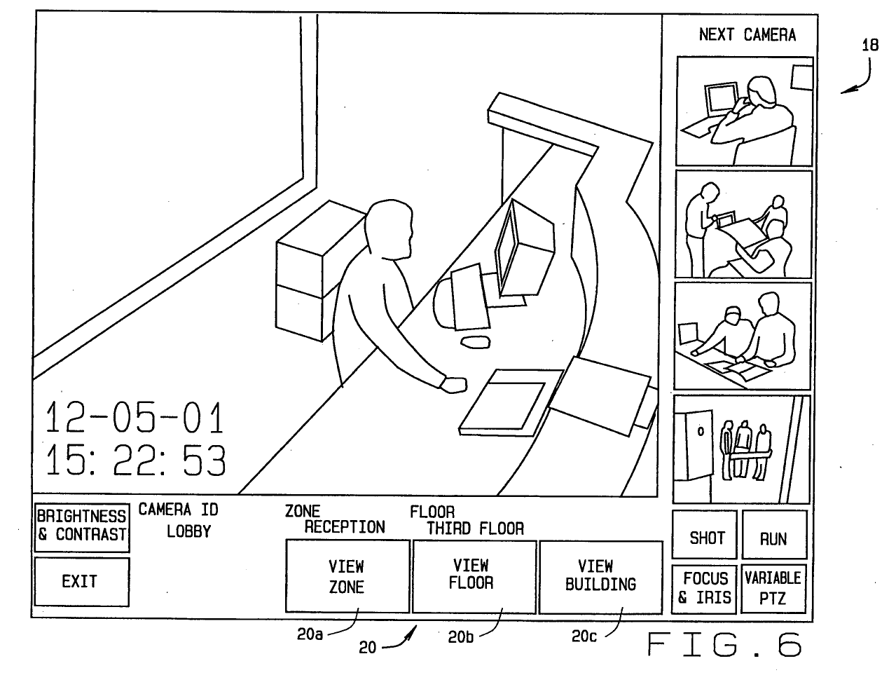

In addition to touch screen monitor 18 for viewing the images obtained from a camera 0, system 10 also includes a selection means 20 for selecting which camera image to display. As described further herein, the camera selected is a camera in the path the person is taking through the facility. In FIG. 5, for example, the selection means comprises a portion of touch screen monitor 18 and is located on the lower right side of the screen. In FIG. 6, the selection means is located along the bottom of the screen. The selection means includes areas 22 within the touch screen by which an operator or observer can view an area (zone, floor, building) merely by touching the appropriate area. In FIG. 5, a portion of the representation of a floor is depicted, including the location of various cameras C located on that floor. Each camera is numbered as indicated in the Fig.

A tracking system 30 of the system is designed to facilitate observation by the security personnel as a person or object passes through the facility. The tracking system is responsive to a selected camera C1-Cn for selecting one or more additional cameras are positioned along one of the pathways a person (or object) will follow in a normal progression of movement through the facility from their current location. Monitor 18, displays not only images from the selected camera SC as shown in FIG. 6, but also reduced size images from each of the other selected cameras, as indicated at NC1-NC4 in FIG. 6. Tracking system 30 automatically changes the selection of cameras whose images are displayed on monitor 18 in response to the pathway, and changes in pathway, taken by the person or object so to track their movement through the facility.

Tracking system 30 first allows someone monitoring the facility from control console 12 to identify an intruder within the facility. This would occur, for example, by multiplexing the input from each camera C1-Cn and displaying it on a monitor 18 with someone viewing the monitor noting the presence of the intruder. Or, as is known to those skilled in the art, techniques are available by which a reference image is obtained for each camera by an image processing system. Periodically, a new image is obtained from the camera and compared with the reference image. If there is a difference between the images which is not attributable to ordinary changes which might be experienced in the scene viewed by the camera, the image is routed to monitor 18 for viewing by someone at the console. Such a system is available, for example, from the assignee of the current application under their trademark SECURVISION®.

Regardless of the detection technique employed by the system, once an intruder is detected by a camera, the video output from the camera is displayed on the SC portion of monitor 18. At this time, the console operator initiates recording of the camera imagery; although the system can be set-up to automatically begin recording in the event of a detection. The console operator can use the various control switches located along the bottom of the monitor, at the right and left sides of the monitor, to control operation of camera C to obtain the best possible image of the intruder. These camera control functions include brightness and contrast, focus and iris settings, and pan, tilt, and zoom (PTZ) of the camera.

Next, tracking system 30 notes the location of the camera C whose imagery is being displayed on the main portion SC of monitor 18 and identifies those cameras adjacent camera C which are in respective paths the intruder must take from his current location. This allows the console operator to now follow the intruder's progress by successively queuing up the next camera or cameras in the person's path. In the overview of each floor, as shown in FIG. 4, whenever a camera is selected for display, the indicia for that camera on the display screen is highlighted. Now, with one camera's imagery being displayed on the SC portion of monitor 18, and that of other cameras as the reduced size images on portions NC1-NC4, the operator can rapidly sequence from one camera to another so as to not lose track of the intruder. As the intruder moves out of range of one camera into that of another, the operator can switch the full size screen display from the one camera to the next. The reduced size image for the new camera now becomes the full size image on screen portion SC of monitor 18 while that of the previous camera is moved to one of the reduced size portions.

Over time, as the intruder progresses through the facility, the console operator can rapidly move from cameras on one part of a floor to those on other parts of the floor. If the intruder goes from one floor to another, the operator can change floors, as indicated in FIG. 2, so that cameras on the floor to which the person moves are now used for tracking. It will be appreciated that while not shown in the drawings, cameras are also located in stairwells by which a person moves from one floor to another, so his movements can be tracked there as well. If the person uses an elevator, when the person selects the floor to which he wants the elevator to go, a signal is provided to the tracking system so a camera monitoring the elevators on the selected floor are queued up to monitor the person when the elevator reaches the floor. If the person leaves the building, cameras monitoring the exterior of the building and the surrounding grounds are queued up to follow his movement. Again, the operator can control each camera, as it is selected, using the control switches on monitor 18.

It will be understood by those skilled in the art that while tracking system 30 enables a control console operator to comprehensively monitor and track movement of a person or an object throughout a facility, the system does not passively respond to the intrusion merely by tracking and recording. In addition, the tacking system can also be programmed to automatically alert security guards, police, or other personnel of the intrusion. If the system is installed manufacturing or processing facility, where its function is to timely monitor movement of an article of manufacture, package, or piece of mail, for example, the system can also be automatically programmed to alert appropriate personnel in the event of a malfunction, a misrouting of the article, or a similar occurrence.

In view of the above, it will be seen that the several objects and advantages of the present invention have been achieved and other advantageous results have been obtained.

1. A closed circuit television (cctv) system for tracking the movement of a person through a facility comprising:
a plurality of cameras located throughout the facility, the individual cameras being located along pathways a person moving through the facility will follow;
a monitor for displaying images from the cameras and selection means for selecting which camera image to display, the camera selected being a camera in a path the person is taking through the facility; and,
tracking means responsive to the selected camera for selecting one or more additional cameras which are positioned along pathways the person would follow in a normal progression of movement through the facility from their current location, the monitor also displaying images from each of these other selected cameras, and the tracking means for changing the selection of cameras whose images are displayed on the monitor in response to the pathway, and changes in pathway, taken by the person thereby to track movement of the person as they move through the facility.

2. The cctv system of claim 1 in which the facility has more than one area in each of which a plurality of cameras are located, the tracking means allowing a user of the system to select which area in which to begin tracking.

3. The cctv system of claim 2 in which representations of each area are displayed on the monitor, each display also indicating the location of each camera installed in the area.

4. The cctv system of claim 3 in which the tracking means enables the user to select which camera's image is displayed at any one time, the selected camera being highlighted on the displayed representation of the area so the user of the system can determine which portion of the area is being observed.

5. The cctv system of claim 1 in which the selected camera is a controllable camera and the monitor includes a touch screen with having defined areas which, when touched by a user of the system allow the user to pan, tilt, or zoom the camera.

6. The cctv system of claim 1 in which the monitor includes a touch screen and provides a full size image display from the selected camera and reduced size image displays from each of the other selected cameras.

7. The cctv system of claim 6 in which the user can change the full size image display from the selected camera to a full size image display of one of the reduced size camera images by touching the portion of the screen where the reduced size image is currently displayed.

8. The cctv system of claim 6 in which, as the person moves through the facility, a user of the system can change the full size image display from the selected camera to whichever of the other selected cameras is now viewing the person by touching the touch screen where the reduced size image of the other selected camera is display, the tracking means, in response to the change in full size image displayed, automatically changing the selection of cameras to those which would next view the person as they moves through the facility.

9. The cctv system of claim 8 further including recording means recording the images displayed on the monitor as the person's movement through the facility is tracked.

10. The cctv system of claim 1 in which the tracking means automatically changes the selection of cameras from those previously selected to a new selection based upon the location of the newly selected camera.

11. A method of tracking the movement of a person within a defined area using a closed circuit television system comprising:
installing a plurality of cameras at predetermined locations within the area with individual cameras being installed along paths over which a person passing through the area will travel;
displaying images from the cameras on a monitor;
selecting which camera whose image is displayed, the camera selected being a camera in a path the person is taking through the area; and,
tracking the person through the area using a tracking means responsive to the selected camera for selecting one or more additional cameras positioned along pathways the person would follow in moving through the area from their present location, the tracking means allowing a user to change the selection of cameras whose images are displayed in response to the pathway, and changes in pathway, taken by the person.

12. The method of claim 11 in which the monitor is a touch screen monitor, and the images displayed are both full size and reduced size images.

13. The method of claim 12 in which the image displayed from selected camera is displayed as a full size image.

14. The method of claim 13 in which the monitor displaying images from each of these other selected cameras displays the images as reduced size images.

15. The method of claim 11 in which the selected camera is a controllable camera and the touch screen has defined areas which, when touched by a user of the system, allow the user to pan, tilt, or zoom the camera.

16. The method of claim 11 further including recording the images displayed on the monitor as the person's movement through the area is tracked.

17. The method of claim 11 in which there are a plurality of areas through a person may proceed, and the method includes allowing a user to select which area to monitor.

18. The method of claim 14 in which a representation of the area is displayed on the monitor, including the location of each camera installed in the area and the camera whose image is being displayed as a full size image on the monitor is highlighted so the user of the system can determine which portion of the area is being observed.

19. The method of claim 14 in which the user can change the full size image display from the selected camera to a full size image display of one of the other selected cameras by touching the portion of the screen where the reduced size image display is presented.

20. The method of claim 19 in which, as the person moves through the area, a user of the system can change from the selected camera whose image is displayed full size to one of the other selected cameras whose image is displayed in reduced size by touching the touch screen where the reduced size image of the other selected camera is displayed, the previously reduced size image now being displayed full size, and the previously full size image now being displayed reduced size.
